(19) United States
(12) Patent Application Publication
(10) Pub. No.: US 2005/0076644 A1
(43) Pub. Date: Apr. 14, 2005

(54) Quiet combustor for a gas turbine engine

(76) Inventors: Canan Uslu Hardwicke, Niskayuna, NY (US); Liang Jiang, Guilderland, NY (US); Sung Jin Kim, Guilderland, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/682,227

(22) Filed: Oct. 8, 2003

(51) Int. Cl. F02C 7/24

(52) U.S. Cl. 60/772; 60/725

(57) ABSTRACT

A combustor and combustor liner cap assembly for reducing noise emissions and acoustic dynamics during operation of a gas turbine generally includes a cellular solid media disposed in the combustor liner cap assembly. The cellular solid media absorbs noise emissions and acoustic dynamics, thereby reducing stresses and vibrations on the combustor assembly associated with operation of the gas turbine.

### BACKGROUND

This disclosure generally relates to gas turbine engines, and more particularly, to combustor assemblies for gas turbine engines.

Operation of turbines generates an undesirable amount of noise that can be attributed to the high firing temperatures generally employed and the dynamic pressure oscillations within a combustor assembly. The increase of dynamic activities can cause damage to the various components that form the combustor assembly, thereby requiring frequent maintenance and repair. For example, combustor assemblies generally include an effusion plate. The effusion plate is prone to damage from exposure to noise and thermal stresses during operation. FIG. 1 pictorially illustrates a damaged effusion plate, generally designated 2. Portions of the effusion plate 2 have fractured leaving various sized fractured openings 4 within the effusion plate.

Prior art attempts to reduce noise include the use of multi-fuel nozzle configurations to provide different flame temperatures within the combustor. However, this approach does not necessarily address the problems associated with the ever-increasing firing temperatures and the pressure oscillations that result. Other attempts include placing a sound absorber in the exhaust conduits. FIG. 2 graphically illustrates pressure as a function of frequency as measured in a prior art annular type combustor assembly. The presence of discrete tones at about 190 and 350 Hertz are observed, which can cause damage to the turbine components. Accordingly, there is a need for reducing the acoustic dynamics and thermal mechanical deformations of the various components that form the combustor assembly.

### BRIEF SUMMARY

Disclosed herein is a combustor and a combustor cap liner assembly comprising a combustor having a combustor casing and a combustion liner within the combustor casing, wherein the combustion liner is closed at a forward end by the combustor liner cap assembly, the combustor including a cellular solid media disposed within the combustor liner cap assembly and/or between the combustion liner cap assembly and an end cover to the combustor.

In another embodiment, the combustor and a combustor cap liner assembly comprises a combustor having a combustor casing and a combustion liner within the combustor casing, wherein the combustion liner is closed at a forward end by the combustor liner cap assembly, the combustion liner cap assembly comprising a cellular solid media in a space defined by opposing surfaces of a circular plate, a burner tube, and an effusion plate of the combustion liner cap assembly.

In yet another embodiment, the combustor and a combustor cap liner assembly comprises a combustor having a combustor casing and a combustion liner within the combustor casing, wherein the combustion liner is closed at a forward end by the combustor liner cap assembly, the combustion liner cap assembly consisting essentially of a cellular solid media having annularly arranged burner tube openings therethrough for supporting a burner tube extending therethrough.

A process for reducing noise emissions in a combustor of a gas turbine comprises disposing cellular solid media within the combustor in an amount and at locations effective to reduce the noise emissions relative to the combustor without the foam; and operating the gas turbine.

The above described and other features are exemplified by the following detailed description and figures.

### BRIEF DESCRIPTION OF FIGURES

Referring now to the figures wherein like elements are numbered alike:

FIG. 1 pictorially illustrates a damaged effusion plate of a combustor for a gas turbine;

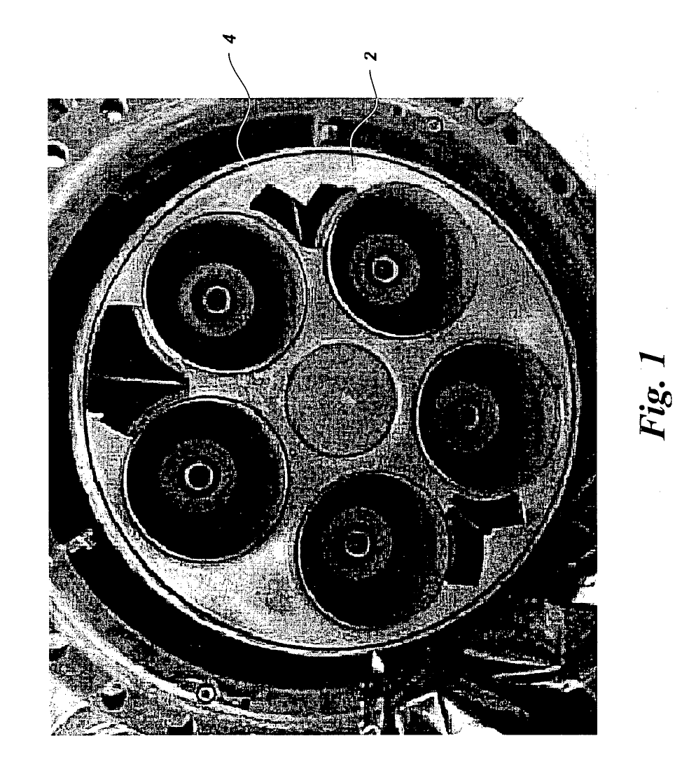

FIG. 2 graphically illustrates pressure oscillations as a function of frequency as measured inside an prior art annular-type combustor;

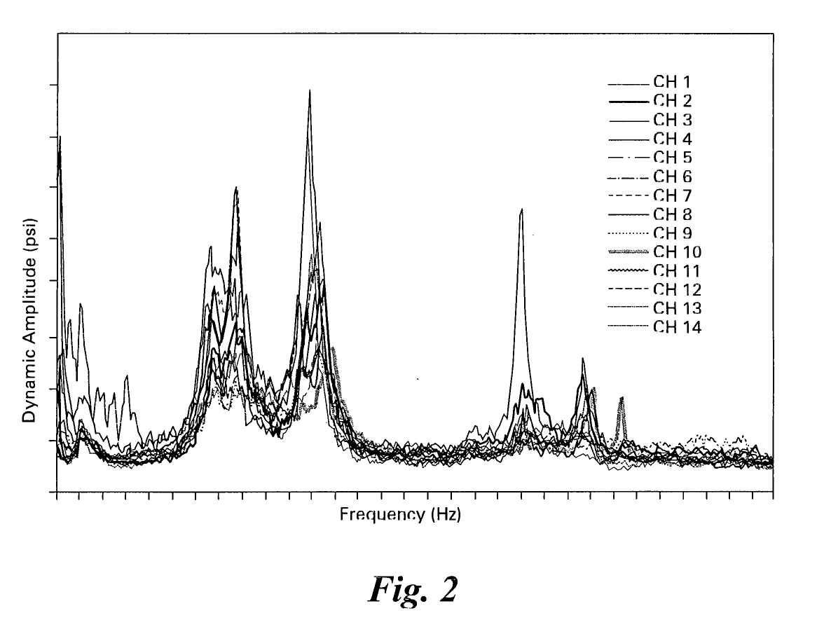

FIG. 3 is a partial cross sectional view of a gas turbine combustor;

FIG. 4 is a cross sectional view of a combustor liner cap assembly;

FIG. 5 is an upstream end view of the combustor liner cap assembly of FIG. 4;

FIG. 6 pictorially illustrates cross sectional views of suitable cellular solid media; and

FIG. 7 graphically illustrates the sound absorption coefficient as a function of frequency for a simulated combustor and combustor liner cap assembly including cellular solid media relative to the same simulated combustor and combustor liner cap assembly that does not include the cellular solid media tested at room temperature.

### DETAILED DESCRIPTION

Disclosed herein is a combustor assembly for reducing noise emissions during operation of a gas turbine. More particularly, the combustor assembly comprises a cellular solid material disposed therein for absorbing and reducing the noise emissions. In a preferred embodiment, the cellular solid material is disposed in and/or about the combustion liner cap assembly as will be described herein.

As used herein the term “cellular solid material” is defined as an interconnected network of solid struts or plates, which form the edges and faces of cells. More commonly, two-dimensional cellular materials are generally termed as honeycombs, and three-dimensional materials are generally referred to as foams. When the solid of which the foam is made is contained only in the cell edges, the foam is said to be open-celled. If the faces are solid so that each cell is sealed off from its neighbors, it is said to be closed-celled. And of course, some foams are partly open and partly closed.

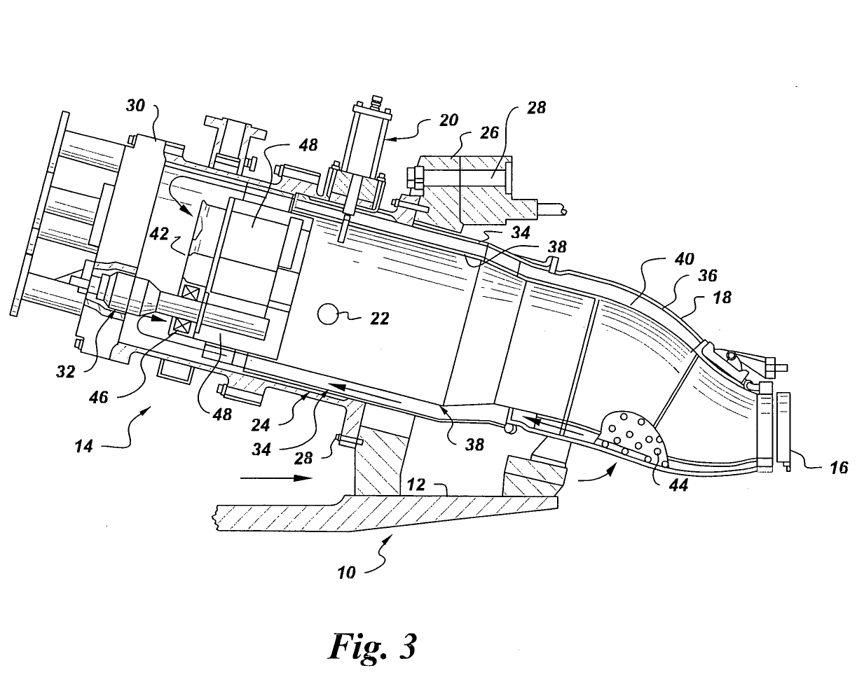

The combustor assembly generally includes a reverse flow can-type combustor having an array of premixers. As is generally known, the array of premixers can act independently of one another, if desired. Referring now to FIG. 3, a conventional gas turbine 10 generally includes a compressor 12 (partially shown), a plurality of combustors 14 (one shown), and a turbine represented here by a single blade 16. Although not specifically shown, the turbine is drivingly connected to the compressor 12 along a common axis. The compressor 12 pressurizes inlet air, which is then reverse flowed to the combustor 14 where it is used to cool the combustor and to provide air to the combustion process.

As noted above, the gas turbine includes a plurality of combustors 14 located about the periphery of the gas turbine. A double-walled transition duct 18 connects the outlet end of each combustor with the inlet end of the turbine to deliver the hot products of combustion (i.e., combustion gases) to the turbine. Ignition is achieved in the combustors by means of a spark plug 20 in conjunction with crossfire tubes (represented by aperture 22) that transfer the flame to adjacent combustors in conventional fashion.

Each combustor 14 includes a substantially cylindrical combustor casing 24 that is secured at an open aft end to the turbine casing 26 by means of bolts 28. The forward end of the combustor casing is closed by an end cover assembly 30 which may include conventional supply tubes, manifolds and associated valves, and the like, for feeding gas, liquid fuel, and air (and water if desired) to the combustor. The end cover assembly 30 receives a plurality of fuel nozzle assemblies 32 (for example five, with only one shown for purposes of convenience and clarity) arranged in a circular array about a longitudinal axis of the combustor.

Within the combustor casing 24, there is mounted, in substantially concentric relation thereto, a substantially cylindrical flow sleeve 34 that connects at its aft end to the outer wall 36 of the double walled transition duct 18. The flow sleeve 34 is connected at its forward end to the combustor casing 24 at a butt joint, where fore and aft sections of the combustor casing are joined.

Within the flow sleeve 34, there is a concentrically arranged combustion liner 38 that is connected at its aft end with the inner wall 40 of the transition duct 18. A combustion liner cap assembly 42 secured to the combustor casing supports the forward end of the combustion liner. It will be appreciated that the outer wall 36 of the transition duct 18, as well as a portion of flow sleeve 34 are formed with an array of apertures 44 over their respective peripheral surfaces to permit air to reverse flow from the compressor 12 through the apertures 44 into the annular (radial) space between the flow sleeve 34 and the liner 38 toward the upstream or forward end of the combustor (as indicated by the flow arrows shown in FIG. 3).

At the forward end of the cap assembly 42, the air reverses direction again, flowing through swirlers 46 surrounding each nozzle, and into pre-mix tubes 48 that are also supported by the liner cap assembly 42. Note that the nozzles extend into the pre-mix tubes.

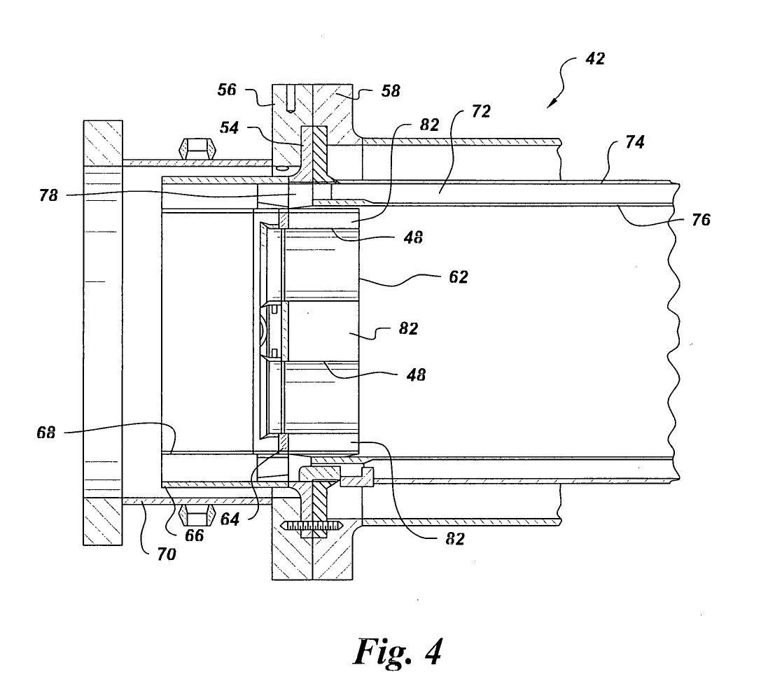

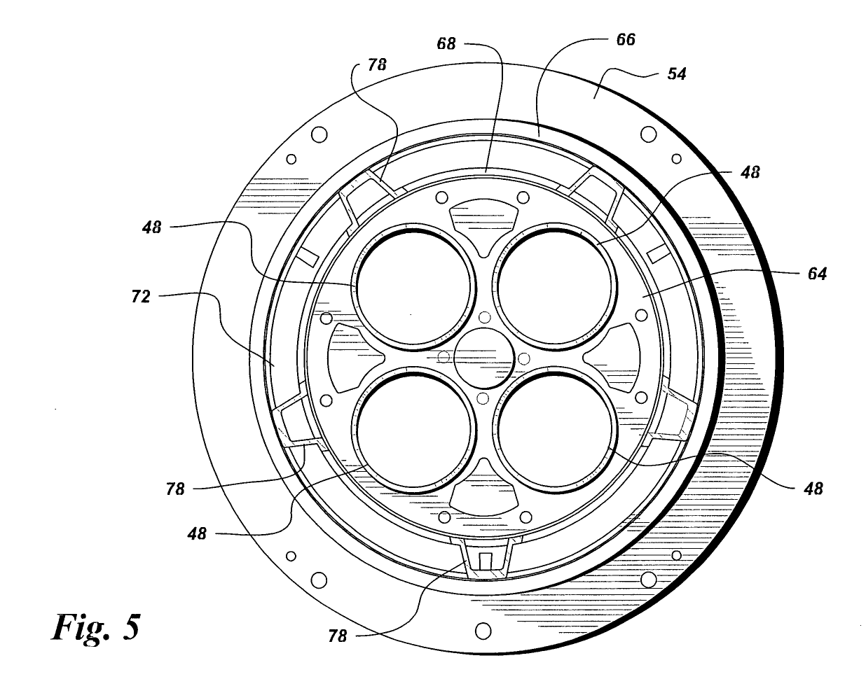

FIGS. 4 and 5 illustrate various views of the exemplary combustion liner cap assembly 42 as shown in FIG. 3. The exemplary cap assembly 42 includes a radial flange 54 by which the cap assembly is secured between forward and aft turbine combustor casing components 56, 58, utilizing bolts and locating pins in conventional fashion. The cap assembly 42 further includes the plurality of annularly arranged pre-mix burner tubes 48 with an optional effusion plate 62 at the aft end thereof. The pre-mix burner tubes 48 are themselves mounted in a circular plate 64. Cylindrical outer body 66 forms an outer radial surface extending from the flange 54 whereas cylindrical inner body 68 forms an inner radial surface. An enlarged cylindrical portion 70 of the forward combustor casing component 56 accommodates and houses the diffuser portion of the combustor. Optionally, outer body 66 is conical shaped and engages the cylindrical portion 70. During operation, air flows in the annular flow passage 72 between the flow sleeve 74 and combustion liner 76, and that radial space is maintained between the diffuser inner body 68 and outer body 66 by means of spacers or webs 78. The airflow then turns at the forward end of the combustor into inner body 68, and subsequently into the premix burner tubes 48.

Spaces 82 are therebetween formed by the surfaces defining the burner tubes 48, circular plate 64, and the optional effusion plate 62. The present disclosure is directed to the use of cellular solid media within space 82 to reduce noise during operation of the turbine. The cellular solid media can occupy the complete space 82 or a portion thereof. In a preferred embodiment, the cellular solid media is preferably circumferentially disposed about at least one burner tube 48. The cellular solid media can be of single uniform construction or may comprise a plurality of different cellular solid media having the same or different properties depending on the application.

In an alternative embodiment, the cellular solid media structurally replaces the circular plate 64 as well as eliminates the need for an effusion plate 62 and provides the necessary support for the burner tubes 48. In this embodiment, the outer cellular solid media preferably fills the space between the burner tube 48 and the inner surface of the combustor cap assembly 42, with a thickness preferably about the length of the burner tubes 48. The cellular solid media reduces turbine-generated noise via absorption of sound waves and/or damping of structural vibration within the combustion liner cap assembly 42. The cellular solid media is preferably a structured material having at least some degree of reticulated or interconnected open cells as previously defined. The structured material absorbs pressure waves in a series of tortuous flow paths; hence, sound absorption by a structured material often depends on properties of the materials including modulus, density, or the like; and characteristics of the cellular media including cell or pore size, degree of interconnectedness, porosity, density and the like.

In one embodiment, suitable cellular solid media are oxidation resistant metal alloys and/or metal superalloys capable of withstanding operating temperatures of 1,000° F. or greater. The cellular solid media may comprise a lattice network, foam, honeycomb, or the like. The interconnecting passageways contained therein may be circular, polygon shaped, or a combination thereof. Suitable alloys include, but are not intended to be limited to, metal alloys and/or superalloys comprising chromium, aluminum, cobalt, nickel, iron, tungsten, molybdenum, titanium, and combinations comprising at least one of the foregoing metals. An exemplary metal alloy is of the formula MCrAlY, wherein M stands for iron, nickel, cobalt, and combinations comprising at least one of the foregoing metals. For example, suitable cellular solid media include foams of CoNiAlY, CoNiCrAlY, CoCrAlY, NiCoCrAlY, NiCrAlY, and the like. Suitable metal alloy foams are commercially available from Porvair Advanced Materials.

In an alternative embodiment, the cellular solid media is a ceramic material. Suitable ceramic materials include silica, alumina, zirconia, ytrria stabilized zirconia, oxides, or combinations comprising at least one of the foregoing. Exemplary cellular solid media are aerogels. Aerogels are particularly advantageous since the speed of sound in aerogel materials is extremely slow, i.e., about 100 meters/second and the thermal conductivities are reported to be as low as 0.009 Watts per meter Kelvin (W/mK) at 100° F. Aerogels can be made from a variety of materials including, but not limited to, silica, alumina, titania, hafnium carbide, and a variety of polymers as is known by those skilled in the art. Suitable commercial aerogels are available under the trademarks PYROGEL and SPACELOFT by Aspen Aerogels, Inc.

The pore density of the cellular solid media is preferably greater than about 5 pores per inch (ppi). More preferably, the pore density is at about 5 to about 500 ppi, with a pore density of about 25 to about 250 ppi even more preferred, and a pore density of about 50 to about 150 ppi most preferred.

The density of the cellular solid media relative to the density of bulk, nonporous solid with the same chemistry is preferably equal to or less than about 50 percent, with a density equal to or less than about 30 percent more preferred, and a density equal to or less than about 10 percent even more preferred. Also preferred, is a density of the cellular solid media equal to or greater than about 1 percent of the density of bulk, nonporous solid, with a density equal to or greater than about 3 percent more preferred, and a density equal to or greater than about 10 percent most preferred. In a preferred embodiment, the density of the cellular solid media relative to the density of the bulk, non-porous solid with the same chemical composition is about 3 to about 10 percent. It is noted that as the relative density increases, the cell walls of the cellular solid media generally thicken and the pore size shrinks.

The International Union of Pure and Applied Chemistry has recommended a classification for porous materials where pores of less than 2 nm in diameter are termed “micropores”, those with diameters between 2 and 50 nm are termed “mesopores”, and those greater than 50 nm in diameter are termed “macropores”. The present disclosure is not intended to be limited to any particular pore size. Silica aerogels generally possess pores of all three sizes.

In other embodiments, the cellular solid media is varied to provide different absorption characteristics. For example, discs of foam media having different porosities can be employed to provide greater absorption or damping properties at certain noise frequencies or pressure oscillations. Optionally, apertures in addition to the pores inherent to the cellular solid media can be bored into the media to provide desired damping characteristics and acoustical absorption properties.

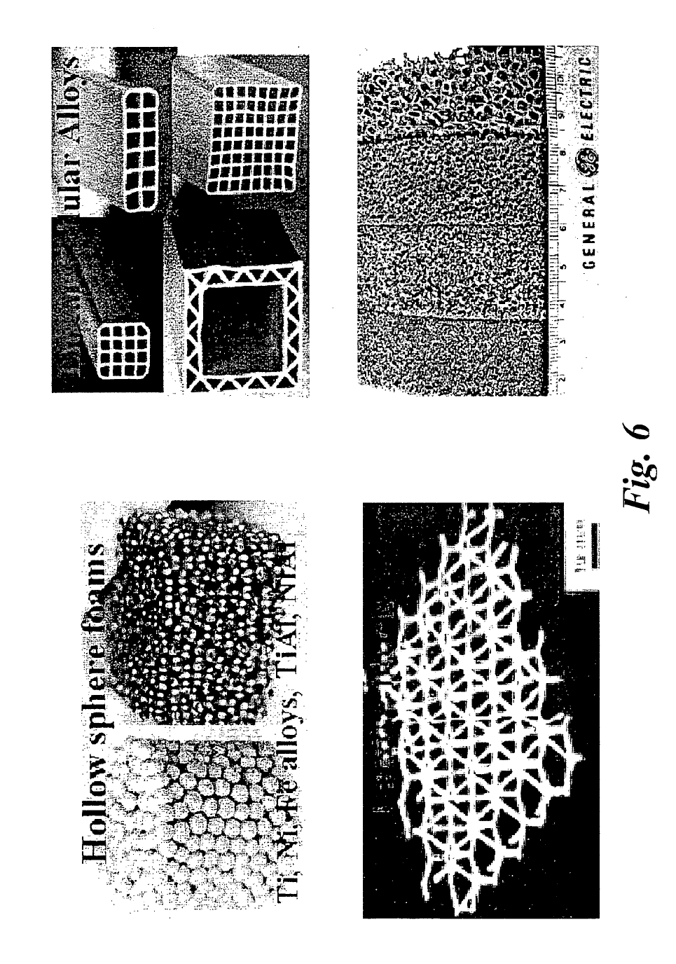

The cellular solid media can have a variety of geometries. FIG. 6 illustrates various exemplary geometries and configurations for defining the pores including open cell foams, hollow sphere foams, lattice block foams, and linear cellular foams. For the purposes of the present disclosure, all of these configurations are suitable for reducing noise emissions in the combustor. As previously discussed, the pores defined by these various configurations can have one or more various shapes characterized as ellipsoidal, polygonal, circular, more complex shapes, or the like. Additional openings can be cut or formed in the cellular solid media such as may be desired for using the cellular solid media in place of the circular plate in which the burner tubes are supported thereby.

Although reference has been made to disposing the cellular solid media in the combustion liner cap assembly, it is not intended to be limited to the combustion liner cap assembly. Other desirable locations, individually or in combination with the combustion liner cap assembly locations as described above, include disposing the cellular solid media in the space between the end cap 30 and the combustion liner cap assembly 42. In a preferred embodiment, cellular solid media having different porosities are employed in various regions within the combustor.

The following examples are provided to illustrate some embodiments of the present disclosure. They are not intended to limit the disclosure in any aspect.

### EXAMPLE 1

In this example, a combustion liner cap assembly was fabricated with the cellular solid media. Abutting the circular plate 64 was an aerogel of a low density, highly porous material. Proximate to the aerogel material was cellular solid media having a porosity of 100 ppi. Spaced apart from the 100 ppi cellular solid media were additional discs of cellular solid media having a porosity of 50 ppi with openings having a diameter of about 0.25 inches drilled into the media. Two of these layers were spaced apart and disposed in the combustion liner cap assembly.

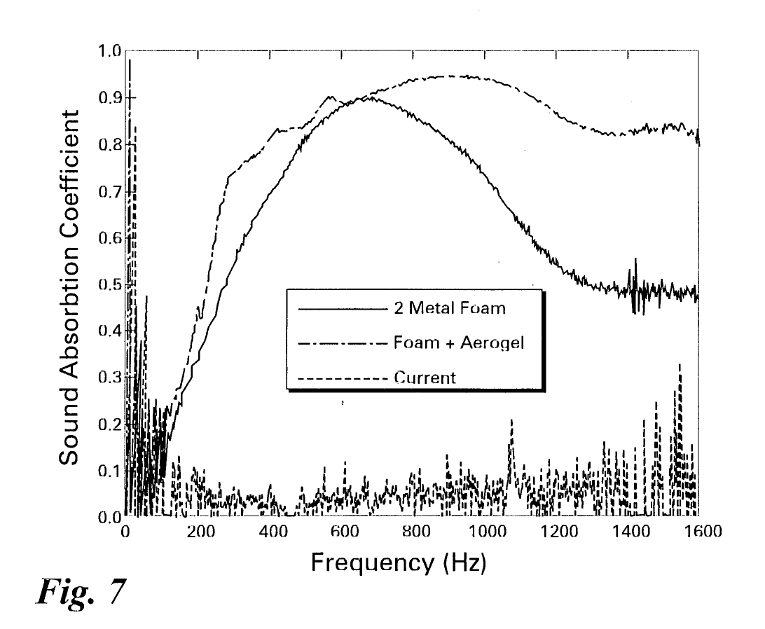

FIG. 7 graphically illustrates the sound absorption as a function of frequency in the simulated combustor liner cap assembly, where a circular tube and acoustic source are used to resemble the dynamic condition of a combustor assembly. Without the use of the cellular solid media, sound-damping capabilities was relatively poor. By employing cellular solid media in the combustor, the sound absorption coefficient significantly increased over a broad frequency spectrum as shown.

Advantageously, employing the cellular solid media within the combustion liner cap assembly as described herein provides broadband damping without the need for tuning or frequency adjustment. The large absorption volume and normal incident surfaces provided by the media significantly reduces noise emissions. Moreover, by locating the media at the source of the combustor dynamics, reduction of noise emissions is improved. Still further, depending on the desired configuration, the media can be used to replace the circular and effusion plates, if desired, and still provide a significant reduction in noise emissions.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A combustor and a combustor cap liner assembly, comprising:
a combustor having a combustor casing and a combustion liner within the combustor casing, wherein the combustion liner is closed at a forward end by the combustor liner cap assembly, the combustor including a cellular solid media disposed within the combustor liner cap assembly and/or between the combustion liner cap assembly and an end cover to the combustor.

2. The combustor and a combustor cap liner assembly of claim 1, wherein comprising the cellular solid media in the combustion liner cap assembly is disposed about at least one burner tube extending through the combustion liner cap assembly.

3. The combustor and a combustor cap liner assembly of claim 1, wherein the cellular solid media comprises at least a ceramic material, a metallic material, or a combination thereof.

4. The combustor and a combustor cap liner assembly of claim 1, wherein the cellular solid media comprises an open cell metal foam media, an open cell ceramic foam media, a closed cell foam, a reticulated foam having both closed cells and open cells, a lattice block structure, or a cellular alloy.

5. The combustor and a combustor cap liner assembly of claim 1, wherein the cellular solid media is an aerogel.

6. The combustor and a combustor cap liner assembly of claim 1, wherein the cellular solid media comprises a metal alloy and/or superalloy material.

7. The combustor and a combustor cap liner assembly of claim 6, wherein the metal alloy and or super alloy comprises a metal selected from the group consisting of chrome, aluminum, cobalt, nickel, iron, tungsten, molybdenum, and titanium.

8. The combustor and a combustor cap liner assembly of claim 1, wherein the cellular solid media has a density less than or equal to about 50 percent relative to a bulk density of the media.

9. The combustor and a combustor cap liner assembly of claim 1, wherein the cellular solid media has a density of about 3 percent to about 10 percent relative to the density of a bulk nonporous solid with the same chemical composition as that of the cellular solid media.

10. The combustor and a combustor cap liner assembly of claim 1, wherein the cellular solid media has a pore density greater than about 5 pores per inch.

11. The combustor and a combustor cap liner assembly of claim 1, wherein the cellular solid media disposed within the combustor liner cap assembly and/or between the combustion liner cap assembly and the end cover comprises multiple discs of the media having different porosities.

12. The combustor and a combustor cap liner assembly of claim 1, wherein the cellular solid media disposed within the combustor liner cap assembly and/or between the combustion liner cap assembly and the end cover comprises a single disc.

13. The combustor and a combustor cap liner assembly of claim 1, wherein the cellular solid media comprises a ceramic material.

14. The combustor and a combustor cap liner assembly of claim 1, wherein the cellular solid media comprises a ceramic material comprising silica, alumina, zirconia, ytrria stabilized zirconia, or combinations comprising at least one of the foregoing.

15. A combustor and a combustor cap liner assembly comprising:
a combustor having a combustor casing and a combustion liner within the combustor casing, wherein the combustion liner is closed at a forward end by the combustor liner cap assembly, the combustion liner cap assembly comprising a cellular solid media in a space defined by opposing surfaces of a circular plate, a burner tube, and an effusion plate of the combustion liner cap assembly.

16. The combustor and a combustor cap liner assembly of claim 15, wherein the cellular solid media comprises a ceramic material, a metal material or a combination thereof.

17. The combustor and a combustor cap liner assembly of claim 15, wherein the cellular solid media is an aerogel.

18. The combustor and a combustor cap liner assembly of claim 15, wherein the cellular solid media comprises a metal alloy and/or superalloy material.

19. The combustor and a combustor cap liner assembly of claim 18, wherein the metal alloy and or super alloy comprises a metal selected from the group consisting of chrome, aluminum, cobalt, nickel, iron, tungsten, molybdenum, and titanium.

20. A combustor and a combustor cap liner assembly comprising:
a combustor having a combustor casing and a combustion liner within the combustor casing, wherein the combustion liner is closed at a forward end by the combustor liner cap assembly, the combustion liner cap assembly consisting essentially of a cellular solid media having annularly arranged burner tube openings therethrough for supporting a burner tube extending therethrough.

21. The combustor and a combustor cap liner assembly of claim 20, wherein the cellular solid media comprises a ceramic material, a metal material, or a combination thereof.

22. The combustor and a combustor cap liner assembly of claim 20, wherein the cellular solid media is an aerogel.

23. The combustor and a combustor cap liner assembly of claim 20, wherein the cellular solid media comprises a metal alloy and/or superalloy material.

24. The combustor and a combustor cap liner assembly of claim 23, wherein the metal alloy and or super alloy comprises a metal selected from the group consisting of chrome, aluminum, cobalt, nickel, iron, tungsten, molybdenum, and titanium.

25. A process for reducing noise emissions in a combustor of a gas turbine, comprising:
disposing cellular solid media within the combustor in an amount and at locations effective to reduce the noise emissions relative to the combustor without the foam; and
operating the gas turbine.

26. The process for reducing noise emissions according to claim 25, wherein the cellular solid media is disposed in a combustion liner cap assembly within the combustor.

27. The process for reducing noise emissions according to claim 25, wherein the cellular solid media is disposed in the combustion liner cap assembly in a space defined by a circular plate, an annular end body extending from the circular plate, and a burner tube supported by and disposed in an opening in the circular plate.

28. The process for reducing noise emissions according to claim 25, wherein the cellular solid media comprises a ceramic material, a metal material, or a combination of open cell metal foam media and open cell ceramic foam media.

29. The process for reducing noise emissions according to claim 25, wherein disposing the cellular solid media in the combustion liner cap assembly comprises arranging multiple discs of the cellular solid media in the combustion liner cap assembly, wherein the multiple discs have the same or different porosities.
